(19) United States
(12) Patent Application Publication
(10) Pub. No.: US 2011/0134343 A1
(43) Pub. Date: Jun. 9, 2011

(54) VIDEO PROJECTOR

(75) Inventor: Kazuya Minami, Hirakata-shi (JP)

(73) Assignee: SANYO ELECTRIC CO., LTD., Osaka (JP)

(21) Appl. No.: 12/961,718

(22) Filed: Dec. 7, 2010

(30) Foreign Application Priority Data
Dec. 9, 2009 (JP) 2009-279465

(51) Int. Cl. H04N 5/74

(52) U.S. Cl. 348/748; 348/E05.137

(57) ABSTRACT

A video projector includes a shell case, which accommodates optical components, and a cooling system, which directs ambient air toward the optical components. The cooling system includes a turbulent flow generator arranged in an intake duct. The turbulent flow generator includes a diagonal upstream surface that smoothly changes the direction of an air flow and generates a turbulent flow at the downstream side of the turbulent flow generator. Fine dust particles suspended in the turbulent flow adheres on a downstream surface of the turbulent flow generator and are removed from the air flow.

### CROSS-REFERENCE TO RELATED APPLICATIONS

This application is based upon and claims the benefit of priority from prior Japanese Patent Application No. 2009-279465, filed on Dec. 9, 2009, the entire contents of which are incorporated herein by reference.

### BACKGROUND OF THE INVENTION

The present invention relates to a video projector, and more particularly, to a cooling mechanism for an optical component that optically modulates illumination light from a light source lamp to generate image light.

In the prior art, a so-called three-chip LCD projector includes dichroic mirrors and three liquid crystal panels. The dichroic mirrors separate the light emitted from a light source into red, green, and blue light, which are the three primary colors. The liquid crystal panels combine colored light, which have been optically modulated in accordance with an image signal for each color, and projects an enlarged color image through a projection lens. In such a video projector, an optical system includes optical components that are adversely affected by increases in temperature, such as a light source lamp, liquid crystal panels, polarization plates, and optical compensation plates. When the temperature of such an optical component exceeds a tolerable temperature, images may not be formed accurately. Thus, typical video projectors draw in ambient air to cool the optical components.

However, dust may be suspended in the ambient air. Such dust may enter a video projector and collect on an optical component. In such a case, the collected dust may block light or reflect and diffuse light. This would lower the image quality. Thus, in the prior art, an air filter is arranged in an air inlet of the video projector. Nevertheless, dust particles that are smaller than the mesh size of the air filter pass through the air filter. Such dust particles may collect on an optical component.

Japanese Laid-Open Patent Publication No. 2004-126421 discloses a dust resistant structure, which will now be described with reference to FIG. 4. In this structure, an air guide passage 101 is located at a downstream side of an air inlet and extends between an intake fan and optical components. An air filter is arranged in the air inlet. A sponge-like polygonal dust filter 102 is arranged in the air guide passage 101.

Japanese Laid-Open Patent Publication No. 2007-256899 describes another dust resistant structure, which will now be described with reference to FIGS. 5 and 6. A side case 201 has an air inlet 202. An air filter 203 is arranged in the air inlet 202. A seal 204 closes the gap formed between the air filter 203 and the air inlet 202. Referring to FIG. 6, a first duct 206 and a base duct 207 define an air flow passage. A flat flow regulating plate 205, which is located at the downstream side of the air filter 203, is arranged facing directly toward the air filter 203. Air flows through the air filter 203 and strikes an upstream surface, which extends upright, of the flow regulating plate 205. The air is then circulated through the first duct 206 and toward cooling fans 208 and 209. The dust that passes through the air filter 203 is collected on and captured by the upright surface of the flow regulating plate 205.

### SUMMARY OF THE INVENTION

The example of FIG. 4 requires a double-filter arrangement, which includes the air filter in the air inlet and the dust filter 102. The double-filter arrangement produces an excessively high ventilation resistance. This drastically decreases the intake air amount and cooling efficiency.

In the example of FIGS. 5 and 6, the flow regulating plate 205 faces directly toward the air filter 203 to facilitate the collection of fine dust particles on the upstream surface of the flow regulating plate 205. The arrangement of the flow regulating plate 205 produces an excessively high ventilation resistance that drastically decreases the intake air amount and cooling efficiency. Further, fine dust particles have a tendency to become suspended in flowing air. Thus, the efficiency is low for capturing fine dust particles with the arrangement of the flow regulating plate 205.

One aspect of the present invention is a video projector provided with an optical system including an optical component. The optical system optically modulates illumination light from a light source lamp in accordance with an image signal to generate image light and projects the image light. A shell case accommodates the optical component and includes an air inlet. A cooling system directs a flow of air drawn through the air inlet toward the optical component. The cooling system includes an intake duct that is in communication with the air inlet through an air filter and an intake fan. A turbulent flow generator is arranged in the intake duct. The turbulent flow generator is an obstacle to the air flow. The obstacle includes a diagonal or curved upstream surface that smoothly changes the direction of the air flow, and the obstacle generates turbulent flow at a downstream side of the obstacle.

Another aspect of the present invention is a video projector provided with an optical system including an optical component. The optical system optically modulates illumination light from a light source lamp in accordance with an image signal to generate image light and projects the image light. A shell case accommodates the optical component and includes an air inlet. A cooling system directs a flow of air drawn through the air inlet toward the optical component. The cooling system includes an intake duct that is in communication with the air inlet through an air filter and an intake fan. The intake duct includes a straight portion extending straight and inward from the air inlet and an air-flow redirecting portion extending at a generally right angle from the straight portion. A sink is formed in a corner between the straight portion and the air-flow redirecting portion. The sink has a striking surface facing directly toward air that flows through the straight portion. The air-flow redirecting portion extends from the straight portion at a location separated in an upstream direction from the striking surface.

A further aspect of the present invention is a video projector provided with an optical system including an optical component. The optical system optically modulates illumination light from a light source lamp in accordance with an image signal to generate image light and projects the image light. A shell case accommodates the optical component and includes an air inlet. A cooling system directs a flow of air drawn through the air inlet toward the optical component. The cooling system includes an intake duct that is in communication with the air inlet through an air filter and an intake fan. A turbulent flow generator is arranged in the intake duct. The intake duct includes a straight portion extending straight and inward from the air inlet and an air-flow redirecting portion extending at a generally right angle from the straight portion. A sink is formed in a corner between the straight portion and the air-flow redirecting portion. The sink has a striking surface facing directly toward air that flows through the straight portion. The air-flow redirecting portion extends from the straight portion at a location separated in an upstream direction from the striking surface. The turbulent flow generator is an obstacle to the air flow. The obstacle includes a diagonal or curved upstream surface that smoothly changes the direction of the air flow, and the obstacle generates turbulent flow at a downstream side of the obstacle.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a schematic cross-sectional view showing a cooling system for a video projector according to a first embodiment of the present invention;

FIG. 1(b) is an enlarged partial cross-sectional view showing the cooling system of FIG. 1(a);

FIG. 2(a) is a schematic cross-sectional view showing a cooling system for a video projector according to a second embodiment of the present invention;

FIG. 2(b) is an enlarged partial cross-sectional view showing the cooling system of FIG. 2(a);

FIG. 3 is a schematic cross-sectional view showing a cooling system for a video projector according to a third embodiment of the present invention;

FIG. 4 is a cross-sectional view showing a first prior art example of a cooling structure for a video projector;

FIG. 5 is a perspective view showing a second prior art example of a cooling structure for a video projector; and

FIG. 6 is a cross-sectional view showing the cooling structure of FIG. 5.

### DETAILED DESCRIPTION OF THE INVENTION

### First Embodiment

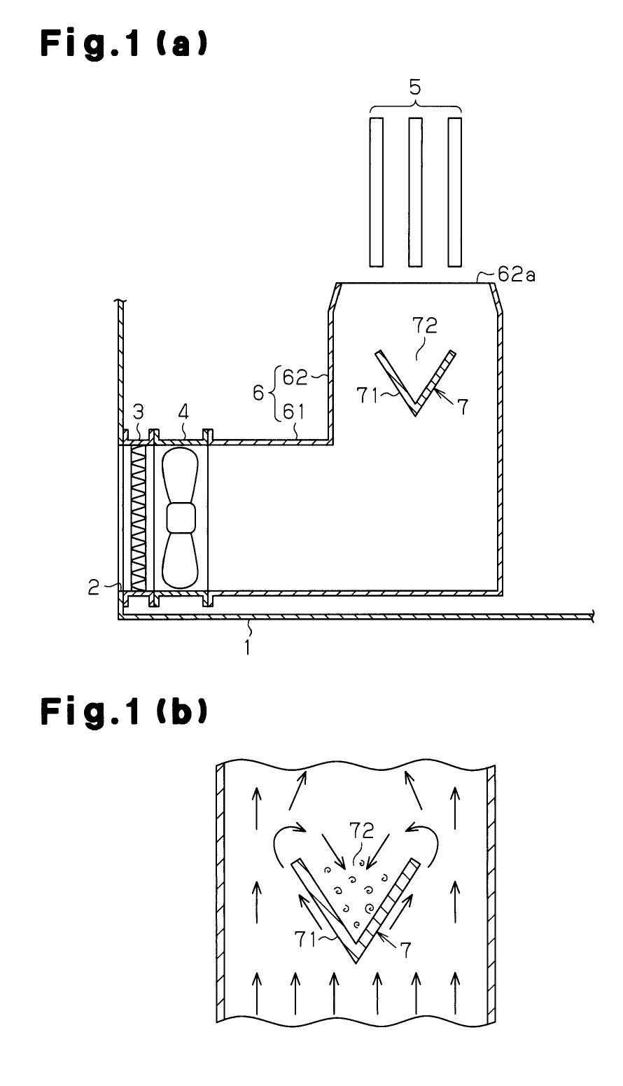

A video projector according to a first embodiment of the present invention will now be discussed with reference to FIGS. 1(a) and 1(b).

The video projector may be, for example, a so-called three-chip LCD projector type, which was described above. The video projector includes an optical system, a shell case 1, and a cooling system. The optical system optically modulates illumination light from a light source lamp in accordance with image signals to generate and project image light. The shell case 1 accommodates optical components of the optical system. The cooling system cools the optical components. The cooling system will now be discussed.

As shown in FIG. 1(a), the shell case 1 includes an air inlet 2. An air filter 3 is arranged in the air inlet 2. An intake fan 4 such as an axial flow fan is arranged at the downstream side of the air filter 3. An intake duct 6 extends from the intake fan 4 to optical components 5, which are to be cooled. The intake duct 6 may be a bent pipe including a straight portion 61 and an angled portion 62. The straight portion 61 extends straight into the shell case 1. The angled portion 62 is in communication with the straight portion 61 and extends at a right angle relative to the straight portion 61. Further, the angled portion 62 diverts the direction of the air flowing from the straight portion 61. The angled portion 62 may be referred to as an air-flow redirecting portion. In the illustrated example, the straight portion 61 extends horizontally, and the angled portion 62 extends vertically. The angled portion 62 has a distal end arranged under the optical components 5 that are to be cooled. The angled portion 62 has an outlet 62a from which the flow of air is directed toward the optical components 5 that are to be cooled. In the illustrated example, the optical components that are to be cooled are liquid crystal light valves. A liquid crystal light valve includes a liquid crystal panel, polarization plates, and optical compensation plates. The crystal panel is arranged between the polarization plates and between the optical compensation plates.

The angled portion 62 includes a turbulent flow generator 7, which is located in the radially central part of the angled portion 62. The turbulent flow generator 7 generates a turbulent flow at the downstream side of the turbulent flow generator 7. In the illustrated example, the turbulent flow generator 7 is an obstacle having a V-shaped cross-section. The obstacle includes an inclined upstream surface 71, which is diagonal to the air flow to smoothly change the direction of the air flow. The obstacle also includes a downstream surface that defines a V-shaped pocket 72. The pocket 72 has an opening located in the downstream direction of the air flow and a bottom located in the upstream direction of the air flow. The turbulent flow generator 7 may be an elongated body that is arranged in the intake duct 6 so as to intersect the direction of the air flow, or a beam.

In the cooling system of the first embodiment, the ambient air that is drawn into the air inlet 2 first passes through the air filter 3. The air filter 3 removes relatively large particles of dust from the ambient air. However, fine dust particles smaller than the mesh size of the air filter 3 may be suspended in the air flowing through the air filter 3. As the air flows into the angled portion 62 from the straight portion 61, the air flow is deflected along the upstream surface 71 of the turbulent flow generator 7. This forms a negative pressure region at a downstream side of the turbulent flow generator 7 and a turbulent flow in the negative pressure region. Part of the turbulent flow is drawn into the pocket 72. In this state, the flow of air that includes fine dust particles repetitively strikes the downstream surface of the turbulent flow generator 7. As a result, fine dust particles suspended in the air flow adheres and collects on the downstream surface of the turbulent flow generator 7. In this manner, fine dust particles are removed from the air flow.

The video projector of the first embodiment has the advantages described below.

(1) The air filter 3 arranged in the air inlet 2 removes relatively large particles of dust from the air drawn into the intake duct 6. Fine dust particles that are smaller than the mesh size of the air filter 3 suspended in the air flow may enter the intake duct 6. However, the air flow including the fine dust particles form a turbulent flow at the pocket 72 located at the downstream side of the turbulent flow generator 7. The fine particles suspended in the air flow collect on the downstream surface of the turbulent flow generator 7. This reduces the amount of fine dust particles that collect on the optical components 5 and improves the image quality.

(2) The upstream surface 71 of the turbulent flow generator 7 is formed to smoothly change the direction of the air flow. Thus, in comparison to the prior art example of FIG. 4 that requires a double-filter arrangement and the prior art example of FIG. 6 that requires a flow regulating plate facing directing toward an air filter, the video projector of the first embodiment has lower ventilation resistance and is more advantageous. Accordingly, fine dust particles are efficiently removed before reaching the optical components 5.

(3) Once the fine dust particles are collected in the turbulent flow generator 7, they are not scattered again when the video projector operates. Since most of dust are removed by the air filter 3, a large amount of fine dust particles does not collect in the turbulent flow generator 7. Thus, waste does not have to be removed from the turbulent flow generator 7.

(4) The downstream surface of the turbulent flow generator 7 is formed so as to define the pocket 72. This facilitates the generation of a turbulent flow (e.g., Karman vortex) at the downstream side of the turbulent flow generator 7. Since the flowing air is easily drawn into the pocket 72, fine dust particles are easily removed from the air flow. In the illustrated example, the upstream surface 71 faces downward, and the pocket 72 has an opening in the downstream direction of the air flow and a bottom in the upstream direction of the air flow. Thus, the fine dust particles easily collect at the bottom of the pocket 72. This effect is particularly noticeable when the pocket 72 is V-shaped.

(5) Preferably, the turbulent flow generator 7 is arranged at the radially central part of the intake duct 6. This increases the amount of flowing air that strikes the downstream surface of the turbulent flow generator 7 and facilitates the removal of fine dust particles from the air flow.

### Second Embodiment

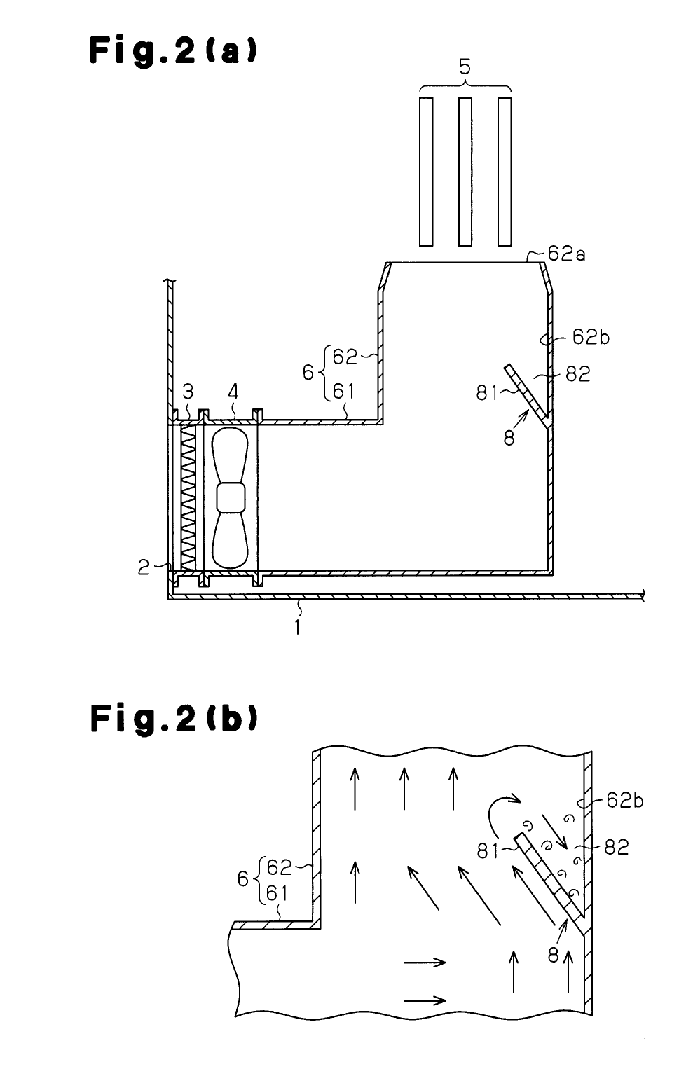

A video projector according to a second embodiment of the present invention will now be discussed with reference to FIGS. 2(a) and 2(b). In FIGS. 2(a) and 2(b), like or same reference numerals are given to those components that are the same as the corresponding components of the first embodiment. Such components will not be described.

The video projector of the second embodiment differs from that of the first embodiment in the structure of the turbulent flow generator. Referring to FIG. 2(a), in the second embodiment, a turbulent flow generator 8 includes a projection plate 81 projecting diagonally upward from an inner duct surface 62b in the angled portion 62 of the intake duct 6. The projection plate 81 has a downstream surface that defines a V-shaped pocket 82 in cooperation with the inner duct surface 62b. The diagonal upstream surface of the projection plate 81 changes the direction of the air flow. The pocket 82 has an opening in the downstream direction of the air flow and a bottom in the upstream direction of the air flow.

In the video projector of the second embodiment, the ambient air that is drawn into the intake duct 6 through the air filter 3 of the air inlet 2 flows toward the angled portion 62, which is an air-flow redirecting portion of the intake duct 6. Fine dust particles smaller than the mesh size of the air filter 3 may be suspended in the flowing air. Referring to FIG. 2(b), the projection plate 81, which projects diagonally upward from the inner duct surface 62b, changes the direction of the air flow. This forms a negative pressure region at a downstream side of the turbulent flow generator 8, and turbulent flow is generated in the negative pressure region. Part of the turbulent flow is drawn into the pocket 82. The flowing air repetitively strikes the downstream surface of the turbulent flow generator 7 (and the inner duct surface 62b). As a result, fine dust particles suspended in the air flow collect on the downstream surface of the turbulent flow generator 7 (and the inner duct surface 62b). In this manner, fine dust particles are removed from the air flow.

In addition to advantages (1) to (4) of the first embodiment, the video projector of the second embodiment has the advantage described below.

(6) The turbulent flow generator 8 of the present embodiment includes the projection plate 81 that projects diagonally upward from the inner duct surface 62b, which forms an air passage, to change the direction of air flow. The downstream surface of the projection plate 81 cooperates with the inner duct surface 62b to define the pocket 82. This simplifies the structure for generating turbulent flow and collecting fine dust particles.

### Third Embodiment

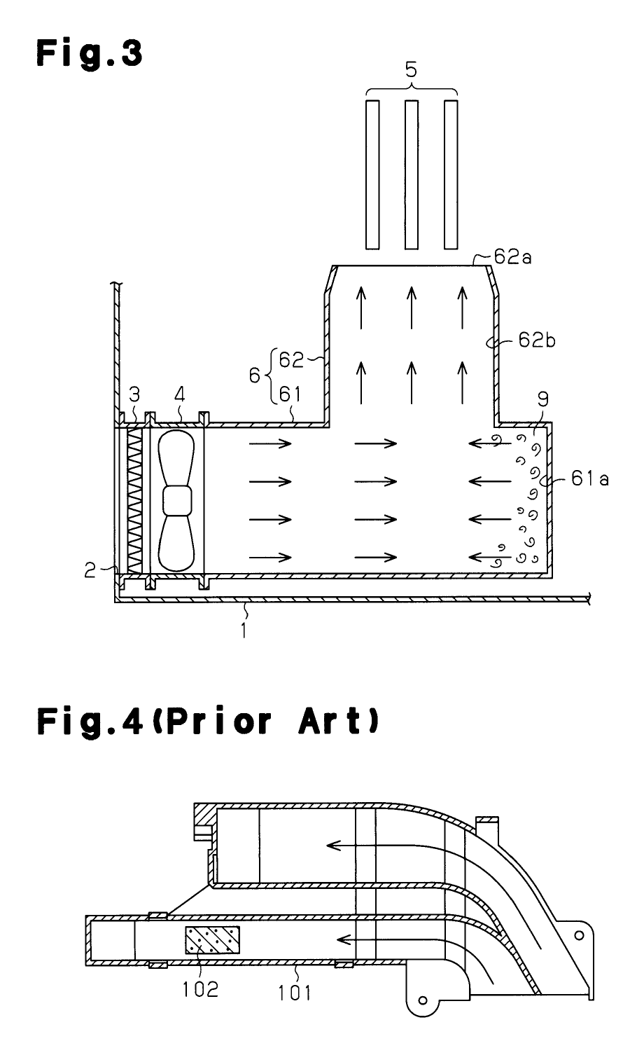

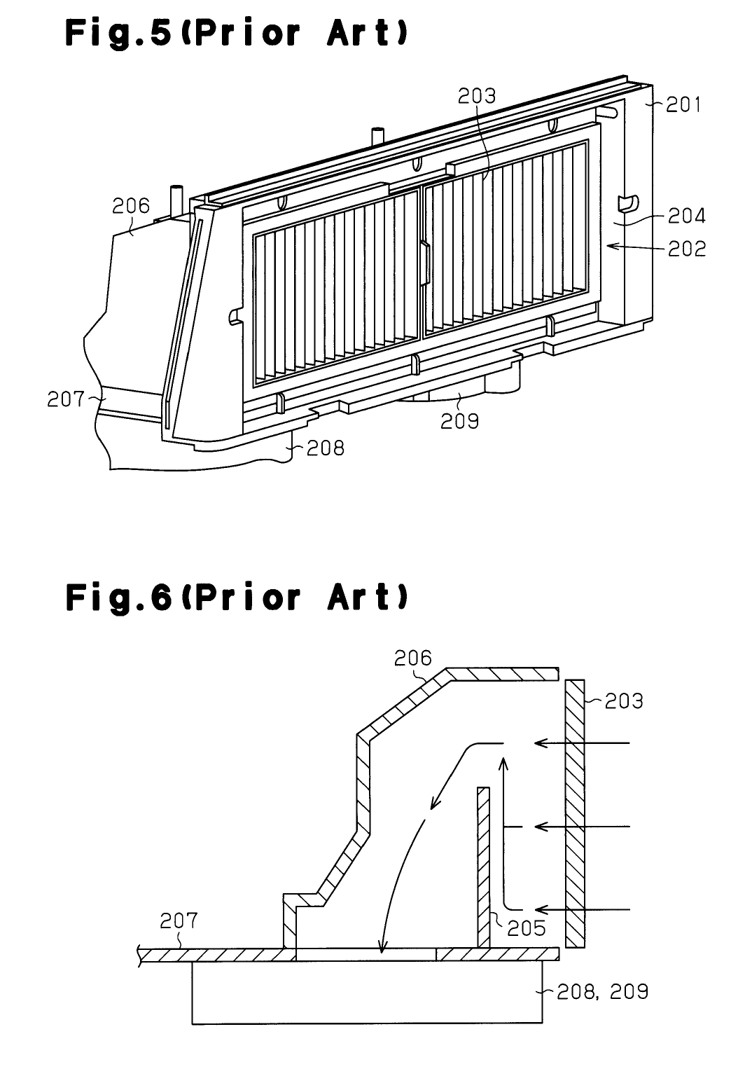

A video projector according to a third embodiment of the present invention will now be discussed with reference to FIG. 3. In FIG. 3, like or same reference numerals are given to those components that are the same as the corresponding components of the first embodiment. Such components will not be described.

The video projector of the third embodiment includes a sink 9, which is a dust-collecting pit arranged at the most distal part of the straight portion 61. Air drifts into the sink 9. The intake duct 6 may be a T-shaped pipe having one closed end. More specifically, the intake duct 6 includes the straight portion 61, which extends straight from the air inlet 2, the angled portion 62, which extends at a generally right angle from the straight portion 61, and the sink 9, which is formed in a corner between the straight portion 61 and the angled portion 62. The sink 9 includes a striking surface 61a facing directly toward the flow of air in the straight portion 61. The angled portion 62 extends from the straight portion 61 at a location separated in the upstream direction from the striking surface 61a. The sink 9 is formed so that the striking surface 61a is spaced apart from the angled portion 62 in the direction in which air flows in the straight portion 61. That is, the sink 9 is formed so that the striking surface 61a is located further toward the right, as viewed in the drawing, from the inner duct surface 62b. Thus, at least some of the air flowing through the straight portion 61 enters the sink 9 before flowing into the angled portion 62.

In the video projector of the third embodiment, the ambient air that is drawn into the intake duct 6 through the air filter 3 of the air inlet 2 flows toward the angled portion 62. Fine dust particles smaller than the mesh size of the air filter 3 may be suspended in the flowing air. Referring to FIG. 3, some of the flowing air enters the sink 9 before flowing to the angled portion 62 and strikes the striking surface 61a. As a result, fine dust particles suspended in the air flow collect on the striking surface 61a. This removes the fine dust particles from the air flow.

The video projector of the third embodiment has advantages similar to advantages (1) to (3) of the first embodiment. In addition, the video projector of the third embodiment has the advantages described below.

(7) The ambient air drawn into the intake duct 6 through the air filter 3 in the air inlet 2 may include fine dust particles that are smaller than the mesh size of the air filter 3. The air including the fine dust particles enters the sink 9. As a result, the fine dust particles are removed from the air flow as they collect on the striking surface 61a. This reduces the amount of fine dust particles that collect on the optical components 5 and improves the image quality.

(8) In contrast to the prior art example of FIG. 6 that requires the flow regulating plate 205 facing directly toward the air filter 203, the sink 9 does not reduce the ventilation area of the intake duct 6. Thus, the sink 9 is advantageous in that it decreases the ventilation resistance. Accordingly, fine dust particles are efficiently removed from the air flow before reaching the optical components.

(9) Once the fine dust particles are collected on the striking surface 61a of the sink 9, they are not scattered. Further, a large amount of fine dust particles does not collect on the striking surface 61a. Thus, waste does not have to be removed from the striking surface 61a.

(10) The sink 9 is located at the most distal part of the straight portion 61. Thus, the air entering the sink 9 and the air returning from the sink 9 form a turbulent flow (in particular, a vortex flow). Thus, more fine dust particles collect on the striking surface 61a.

It should be apparent to those skilled in the art that the present invention may be embodied in many other specific forms without departing from the scope of the invention. Particularly, it should be understood that the present invention may be embodied in the following forms.

In the embodiments described above, the surfaces of the pockets 72 and 82 and the sink 9 may undergo treatment that facilitates the collection of fine dust particles. For example, a paint facilitating fine dust particle collection may be applied to the surfaces. Alternatively, a magnetic sheet may be applied to the surfaces. Such structures improve the dust removal efficiency and image quality.

In the embodiments described above, microscopic valleys and ridges may be formed in the surfaces of the pockets 72 and 82 and the sink 9. In this case, dust particles suspended in the air flow strike the ridges and fall down. This facilitates the collection of dust particles in the surfaces of the pockets 72 and 82 and the sink 9. The microscopic ridges and valleys may be formed by fine grooves or by roughening the surfaces. Such structures improve the dust removal efficiency.

The first embodiment and the second embodiment may each be combined with the sink 9 of the third embodiment. In this case, fine dust particles are removed from the flowing air at two locations, the turbulent flow generator 7 or 8 and the sink 9. Such a combination removes relatively large fine dust particles with the sink 9 and relatively small fine dust particles with the turbulent flow generator 7 or 8.

In the embodiments described above, the intake fan 4 is not limited to an axial flow fan. Other centrifugal fans may be used instead, such as a sirocco fan or a turbo fan.

In the first and second embodiments, the upstream surfaces of the turbulent flow generators 7 and 8 are not limited to surfaces that are diagonal to the air flow and may be curved surfaces. That is, the turbulent flow generator 7 of the first embodiment does not have to be V-shaped and may have another shape. For example, the turbulent flow generator 7 may be semicircular, semielliptical, elliptical, semi-oblong, or parabolic. The same applies for the second embodiment.

The present invention may be applied to various types of video projectors. In other words, the present invention is not limited to a three-chip LCD projector. For example, the present invention may be applied to a projector including a different image generation system or a Digital Light Processing (DLP, registered trademark of Texas Instruments) projector.

The present examples and embodiments are to be considered as illustrative and not restrictive, and the invention is not to be limited to the details given herein, but may be modified within the scope and equivalence of the appended claims.

What is claimed is:

1. A video projector comprising:
an optical system including an optical component, in which the optical system optically modulates illumination light from a light source lamp in accordance with an image signal to generate image light and projects the image light;
a shell case that accommodates the optical component and includes an air inlet; and
a cooling system that directs a flow of air drawn through the air inlet toward the optical component, the cooling system including:
an intake duct that is in communication with the air inlet through an air filter and an intake fan; and
a turbulent flow generator arranged in the intake duct, wherein the turbulent flow generator is an obstacle to the air flow, in which the obstacle includes a diagonal or curved upstream surface that smoothly changes the direction of the air flow, and the obstacle generates turbulent flow at a downstream side of the obstacle.

2. The video projector according to claim 1, wherein the turbulent flow generator includes a downstream surface defining a pocket having an opening in a downstream direction of the air flow and a bottom in an upstream direction of the air flow.

3. The video projector according to claim 2, wherein the turbulent flow generator is arranged in a radially central part of the intake duct.

4. The video projector according to claim 2, wherein the turbulent flow generator includes a projection plate projecting from an inner duct surface of the intake duct to change the direction of the air flow, and the pocket is defined by a downstream surface of the projection plate and the inner duct surface.

5. The video projector according to claim 1, wherein the turbulent flow generator includes at least one surface that has undergone a treatment for facilitating waste collection.

6. The video projector according to claim 2, wherein the intake duct includes a horizontal straight portion and a vertical air-flow redirecting portion, and wherein the obstacle of the turbulent flow generator is arranged in the air-flow redirecting portion such that the upstream surface faces a downward direction and the downstream surface faces an upward direction.

7. The video projector according to claim 4, wherein the projection plate projects diagonally upward from the inner duct surface.

8. The video projector according to claim 1, wherein the obstacle of the turbulent flow generator includes a downstream surface to collect dust suspended in the turbulent flow at the downstream side of the obstacle.

9. A video projector comprising:
an optical system including an optical component, in which the optical system optically modulates illumination light from a light source lamp in accordance with an image signal to generate image light and projects the image light;
a shell case that accommodates the optical component and includes an air inlet; and
a cooling system that directs a flow of air drawn through the air inlet toward the optical component, the cooling system including:
an intake duct that is in communication with the air inlet through an air filter and an intake fan, the intake duct including:
a straight portion extending straight and inward from the air inlet;
an air-flow redirecting portion extending at a generally right angle from the straight portion; and
a sink formed in a corner between the straight portion and the air-flow redirecting portion, wherein the sink has a striking surface facing directly toward air that flows through the straight portion, and the air-flow redirecting portion extends from the straight portion at a location separated in an upstream direction from the striking surface.

10. The video projector according to claim 9, wherein the sink includes at least one surface that has undergone a treatment for facilitating waste collection.

11. The video projector according to claim 9, wherein the intake duct is a T-shaped pipe having one closed end that functions as the sink.

12. A video projector comprising:
an optical system including an optical component, in which the optical system optically modulates illumination light from a light source lamp in accordance with an image signal to generate image light and projects the image light;
a shell case that accommodates the optical component and includes an air inlet; and
a cooling system that directs a flow of air drawn through the air inlet toward the optical component, the cooling system including:
an intake duct that is in communication with the air inlet through an air filter and an intake fan; and
a turbulent flow generator arranged in the intake duct, the intake duct including:
a straight portion extending straight and inward from the air inlet;
an air-flow redirecting portion extending at a generally right angle from the straight portion; and
a sink formed in a corner between the straight portion and the air-flow redirecting portion,
wherein the sink has a striking surface facing directly toward air that flows through the straight portion, and the air-flow redirecting portion extends from the straight portion at a location separated in an upstream direction from the striking surface;
wherein the turbulent flow generator is an obstacle to the air flow, in which the obstacle includes a diagonal or curved upstream surface that smoothly changes the direction of the air flow, and the obstacle generates turbulent flow at a downstream side of the obstacle.
